(19) United States
(12) Patent Application Publication
(10) Pub. No.: US 2010/0332798 A1
(43) Pub. Date: Dec. 30, 2010

(54) Digital Processor and Method

(75) Inventors: Martin Doerr, Boeblingen (DE); Hubert Eichner, Boeblingen (DE); Markus Kaltenbach, Boeblingen (DE); Volker Koch, Boeblingen (DE); Ulrich Mayer, Boeblingen (DE); Thomas Pflueger, Boeblingen (DE); Thomas Schlipf, Boeblingen (DE); Cordt Starke, Boeblingen (DE); Jan Van Lunteren, Rueschlikon (CH)

Correspondence Address: INTERNATIONAL BUSINESS MACHINES CORPORATION;Richard Lau, IPLAW DEPARTMENT / Bldg 008-2, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 12/825,402

(22) Filed: Jun. 29, 2010

(30) Foreign Application Priority Data
Jun. 29, 2009 (EP) 09164014.4

(51) Int. Cl. G06F 15/76; G06F 9/02

(52) U.S. Cl. 712/36; 712/E09.002

(57) ABSTRACT

A processor subunit for a processor for processing data. The processor subunit includes registers, and at least one functional unit for executing instructions on data. One or more registers of the registers are connected to an input of the at least one functional unit, where each register connected to the input of the at least one functional unit which has an input multiplexer. One or more registers of the registers are connected to an output of the at least one functional unit, where each register connected to the output of the at least one functional unit which has an input multiplexer. At least one output bus is connected to at least one register. At least one input bus is connected to at least one register. The processor subunit may be used in a processor, which may be used in a data streaming accelerator.

### CROSS REFERENCE TO RELATED APPLICATIONS

This application claims priority under 35 U.S.C. §119 from European Patent Application No. 09164014.4 filed Jun. 29, 2009, the entire contents of which are incorporated herein by reference

### BACKGROUND

The present invention relates to digital processors operable to execute program instructions for processing and/or streaming data. Moreover, the invention concerns methods of processing and/or streaming data in these digital processors.

Referring to FIG. 1, early computers 10 adopting a “von Neumann”-type architecture were constructed using numerous interconnected integrated circuits for implementing random access data memories (RAM) 20 and associated processors 30. Each processor 30 included program control logic (PCL) 40 and an arithmetic logic unit (ALU) 50. In operation, input data for processing was fetched from its memory 20 and provided to its logic unit (ALU) 50 for having operations executed thereupon to generate corresponding output data for storage in the memory 20. When logic clock speeds were relatively low, for example a few MHz, propagation delays between the memory 20 and the ALU 50 were relatively insignificant in comparison to switching speeds of transistors within the interconnected integrated circuits.

Advances in silicon integrated circuit fabrication, for example achieved using dry-etching fabrication techniques, ion implantation and short-wavelength optical lithographic processes, it has now become feasible to integrate multiple digital processors together onto a single silicon integrated circuit by employing circuit feature dimensions of 100 nm or less, for example 65 nm. As a consequence of such miniaturization, transistor switching speeds have increased dramatically whereas signal propagation delays occurring along interconnects employed within the integrated circuit have not reduced in proportion. Clock speeds of 1 GHz or more are now feasible in such integrated circuits. Changes in interconnect materials from aluminium to copper has provided some reduction in propagation delay, but does not fundamentally address this problem of interconnect propagation delays being significant in comparison to transistor switching speeds.

Integrated circuit designers have therefore evolved contemporary processor design as illustrated in FIG. 2 so that a processor 100 is spatially implemented as a configuration of clusters 110 wherein each cluster 110 includes a functional unit (FU) 120 with associated data registers 130 in close proximity thereto. Input data at a given cluster 110 can be processed at high speed within the given cluster 110 before being transferred to another cluster 110 for subsequent processing there. In an extreme case, such an architecture becomes a transport triggered architecture (TTA). In TTA's, there are multiple FU's wherein each FU has data registers coupled thereto. The registers are susceptible to being implemented as dedicated register files or as partitioned register files. Partitioned register files are optionally implemented as several mutually different smaller register files. The processor 100 is capable of performing concurrent parallel data processing in its functional units (FU) 120 which is beneficial for many types of processing tasks, for example pixel video image processing, matrix manipulations, encoding, decoding and such like.

In a contemporary state-of-the-art general purpose microprocessor, the FU's 120 are fabricated so that, within a given cluster 110, they are completely separate in relation to their associated register files containing register contents. A disadvantage of such a configuration is that more than one hardware cycle is required to transfer data between an FU 120 and its associated register file, for example by way of a pipeline architecture executing multiple steps r₁, r₂ and r₃: step r₁ involves transferring data from the register to the FU 120, step r₂ involves executing a function on the data at the FU 120 to generate processed data, step r₃ involves moving the processed data from the FU 120 to the register. In a published research paper “AMD's Mustang versus Intel's Willamette”, there is described in overview an alleged single cycle arithmetic logic unit (ALU), for example an FU 120 which is imbedded between two staging registers. However, such a configuration still requires data to be transferred from the register file to an input register of the ALU and therefore is, in practice, not genuinely a single cycle arithmetic unit (ALU). The need to perform several cycles presently represents a limitation to a speed of processing achievable using a contemporary state-of-the-art microprocessor.

### BRIEF SUMMARY

It is an object of the invention to provide to increase processing speeds of microprocessors by reducing a number of cycles required for transferring data within the microprocessors.

This object is achieved by the features of the independent claims. The other claims and the specification disclose advantageous embodiments of the invention.

According to a first aspect of the present invention, there is provided a processor subunit for a processor for processing data, wherein the subunit includes:
(i) a plurality of registers;
(ii) at least one functional unit for executing instructions on data;
(iii) one or more registers of the plurality of registers connected to an input of the at least one functional unit;
(iv) each register connected to the input of the at least one functional unit which has an own input multiplexer;
(v) one or more registers of the plurality of registers which are connected to an output of the at least one functional unit;
(vi) each register connected to the output of the at least one functional unit which has an own input multiplexer;
(vii) at least one output bus which is connected to at least one register; and
(viii) at least one input bus is connected to at least one register.

The invention is of advantage in that the processor subunit is capable of functioning at an enhanced rate for processing data.

Particularly, the functional units themselves are free of internal registers. The multiplexors advantageously allow for addressing the desired register so that there is no need for separate read and write ports at each register.

Optionally, the input multiplexors form a cross bar switch, wherein the multiplexors are connected by wires.

Optionally, the output of each functional unit is connected to one or more other registers, preferably to all other registers.

Optionally, registers connected to the input of the at least one functional unit are writable from an output of at least one other functional unit.

Optionally, registers connected to the input of the at least one functional unit are writable from at least one other register.

According to a second aspect of the present invention, there is provided a processor for processing data, said processor including at least one functional unit FU for executing instructions on data, comprising a processor subunit according to any described-above feature.

Optionally, there is provided a processor for processing data, said processor including at least one functional unit (FU) for executing instructions on data, wherein the at least one functional unit (FU) has at least one register associated therewith, said register being operable to hold one or more addresses of one or more registers associated with the at least one functional unit (FU), said one or more registers being addressed by the instructions for providing a direct any-to-any connection between the one or more registers associated with the at least one functional unit (FU), thereby providing a single cycle data path between the at least one functional unit (FU) and its associated one or more registers.

The invention is of advantage in that the processor is capable of functioning at an enhanced rate for processing data.

Optionally, the processor includes a plurality of functional unit (FU), each functional unit (FU) being provided with one or more associated registers, and the processor further comprising one or more buses from at least a sub-set of the functional units (FU) to any of the registers.

Optionally, in the processor, one or more registers operable to store operands served their associated functional units (FU) directly for reducing bypass overheads.

Optionally, the processor is fabricated into an integrated circuit concurrently with a cache memory, streaming logic and a controller coupled to the processor, wherein the integrated circuit is operable to function as a programmable streaming accelerator. More optionally, the controller is coupled to a same nest-frequency clock as the processor.

Optionally, in the processor, the controller is a BaRT-controller which is operable to reconfigure said streaming accelerator in response to receiving reconfiguring instructions.

More optionally, in the processor, the controller is operable to employ three states of “0”, “1” and “don't care” for enabling stating transitions within the streaming accelerator to be achieved without branches.

According to a third aspect of the invention, there is provided a programmable streaming accelerator comprising a processor pursuant to the second aspect of the invention fabricated into an integrated circuit concurrently with a cache memory, streaming logic and a controller coupled to the processor, wherein the integrated circuit is operable to function as the programmable streaming accelerator.

According to a fourth aspect of the invention, there is provided a method of operating a programmable streaming accelerator, pursuant to the third aspect of the invention, the method including:
(a) loading a configuration program from the cache memory to a rule memory for controlling configuring of the accelerator;
(b) receiving one or more inbound data packet requests, and configuring processing modules within the streaming accelerator pursuant to the requests;
(c) validating at least one inbound data packet against control data for defining a destination target; and
(d) granting access rights within the accelerator within the interface for processing an input stream of data pursuant to the configuration program.

It will appreciated that features of the invention are susceptible to being combined in any combination without departing from the scope of the invention.

### BRIEF DESCRIPTION OF THE SEVERAL VIEWS OF THE DRAWINGS

The present invention together with the above-mentioned and other objects and advantages may best be understood from the following detailed description of the embodiments, but not restricted to the embodiments, wherein:

FIG. 1 is an illustration of an earlier computer based upon a “von Neumann”-type architecture;

FIG. 2 is an illustration of a contemporary integrated microprocessor including a plurality of clusters, wherein each cluster is provided with its own associated functional unit (FU);

FIG. 3 is an illustration of a universal programmable streaming accelerator (UPSA);

FIG. 4 is a schematic diagram of an implementation of universal streaming logic (USL) of the UPSA of FIG. 3;

FIG. 5 is an illustration of a configuration of functional units (FU), registers and register output buses for use in a UPSA representing a processor subunit according to the first aspect of the invention; and

FIG. 6 to FIG. 9 are illustrations of processing steps performed in a UPSA.

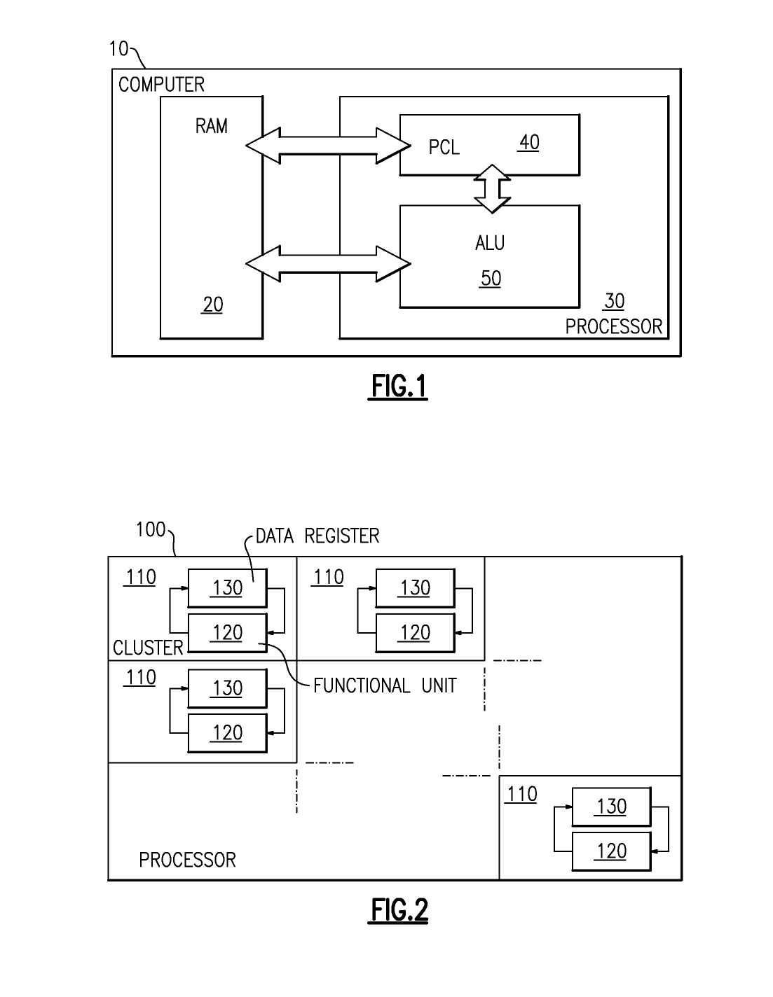

In the drawings, like elements are referred to with equal reference numerals. The drawings are merely schematic representations, not intended to portray specific parameters of the invention. Moreover, the drawings are intended to depict only typical embodiments of the invention and therefore should not be considered as limiting the scope of the invention.

### DETAILED DESCRIPTION

In numerous contemporary electronic systems, there is a need to provide complex streams of processed data, for example in multimedia systems, Internet-coupled apparatus and so forth. The need is addressed by various types of data server architecture which have over time evolved from single-processor servers to multiprocessor servers supporting various software applications for providing database, application and web services in heterogeneous customer environments. Such electronic systems are operable to process various data streams at high speed for achieving efficient data communication. One bottleneck encountered in contemporary state-of-the-art server platforms is limited communication bandwidth for processing data streams between various client software applications.

A contemporary solution to such limited communication bandwidth is to employ dedicated input/out hardware in servers, for example acceleration hardware. Alternatively, another solution is to employ an external interface to interface to processor units of multiprocessor systems. Examples of these contemporary solutions are to be found in IBM's proprietary p- and z-Series server platforms utilizing a proprietary Infiniband architecture for high bandwidth communication. This contemporary architecture exhibits microsecond latencies when handling data streams which is presently acceptable. However, it is desirous in future server platforms that sub-microsecond latencies be achieved. Existing processor designs unfortunately do not allow for sub-microsecond latencies to be achieved.

Contemporary open system architectures utilize various protocols for providing high-speed data stream processing. Such protocols include well-known Infiniband, TCP/IP and Hypertransport. These architectures are also required to perform other functions such as parsing of XML documents, data compression and data encryption. For providing high-bandwidth data processing with low latencies requires aforementioned acceleration hardware because generic contemporary processor architectures are not optimized for executing high-speed data stream processing and other related functions. Thus, contemporary solutions for providing high-speed data stream processing involves use of hardware implementations which are individually designed and adapted for dedicated applications, for example data compression and/or data decoding.

The present invention seeks to increase processing speeds of microprocessors by reducing a number of cycles required for transferring data within the microprocessors. This reduction in cycles enables a universal programmable streaming accelerator (UPSA) to be realized which provides high-speed data processing with low latency. In FIG. 3, there is shown a universal programmable streaming accelerator (UPSA) 200 which comprises universal streaming logic (USL) 210, a programmable BaRT-controller 220, and also a processor core 230 with associated cache memory 240.

The BaRT-controller 220 is described in a published US patent application no. US 2005/0132342 which is hereby incorporated by reference. In the U.S. patent application, there is described an XML parsing system including a pattern-matching system for receiving an input stream of characters corresponding to the XML document to be parsed. The pattern matching system includes two main components: a controller operable to function as a programmable state machine programmed with an appropriate state transition diagram, and a character processing unit operable to function as token and character handler. The programmable state machine is also operable to search for a highest-priority state transition rule using a variation of a BaRT algorithm as described in J. van Lunteren, “Searching very large routing tables in wide embedded memory,” Proceedings of the IEEE Global Telecommunications Conference GLOBECOM'01, vol. 3, pp. 1615-1619, San Antonio, Tex., November 2001.

The UPSA 200 is operable to process various data streams whilst providing high bandwidth and low latency. Moreover, the UPSA 200 is beneficially fabricated onto a single silicon die. The USL 210 and the BaRT-controller 220 constitute an hardware accelerator for speeding up streaming applications, for example network protocol processing, XML-parsing and compression. The UPSA 200 is beneficially coupled to a high nest frequency of the processor core 230. For providing processing incoming and outgoing data steams in parallel, a plurality of the UPSA 200 can be employed. The hardware accelerator is capable of providing benefits of increased data processing speeds, universality and flexibility in respect of different streaming tasks on account of re-programmability of the BaRT-controller 220. The BaRT-controller 220 is configured by loading a program into the controller's memory; such loading of the program can be undertaken at any time without rebooting the UPSA 200. For example, it is possible to execute network protocol processing first and then subsequently switch the UPSA 200 to execute XML-parsing.

The USL 210 is operable to process incoming data by employing a method comprising:
(a) loading and storing data both to and from the cache memory 240 or the USL 210;
(b) modifying data, for example executing addition, subtraction or shift operations;
(c) providing input data for the BaRT-controller 220 from data in registers or results from previous operations, namely by so-called “loopback”.

Loading and storing data is performed by dedicated logic operable to handle data transfers between:
(a) the USL 210 and cache memory 240;
(b) between the USL 210 and its streaming interface 250; and
(c) on a direct connection between the cache memory 240 and streaming interface for performing fast data transfers, for example packet payload transfers.

When data streams of specific applications are to be transferred merely between the cache memory 240 and the USL 210, the streaming buffer 250 can be used as additional memory, for example in a manner of a stack.

Access to a main memory coupled to the UPSA 200 is performed by a cache controller 300 of the processor core 230. Thus, from a viewpoint of the UPSA 200, memory access is processed in a similar manner to cache memory access, namely in a transparent manner. Such a manner of data access enables the UPSA 200 to access data in its cache memory 240 in a very efficient manner. Moreover, cache coherency between different processors 230 is beneficially provided by the microprocessor's cache controller 300. Moreover, the USL 210 is beneficially provided with an interface 310 to an address translation unit (ATU) 320 of the processor core 230 for translating virtual addresses into corresponding physical addresses.

The UPSA 200 beneficially also includes a parallel arithmetic logic unit (ALU) 260 comprising one or more general purpose registers (GPR) 330 together with one or more multiply fully-independent arithmetic units for executing operations, for example additions, subtractions, shift operations and comparison of both 32-bit and 64-bit wide values for modifying and comparing data. In operation, data from the cache memory 240 or from the streaming interface can be loaded into the one or more general purpose registers (GPR) 330 and vice versa. Data stored in the general purpose registers (GPR) 330 can be optionally employed as operands in arithmetic operations or as addresses for both streaming operations or access to the cache memory 240.

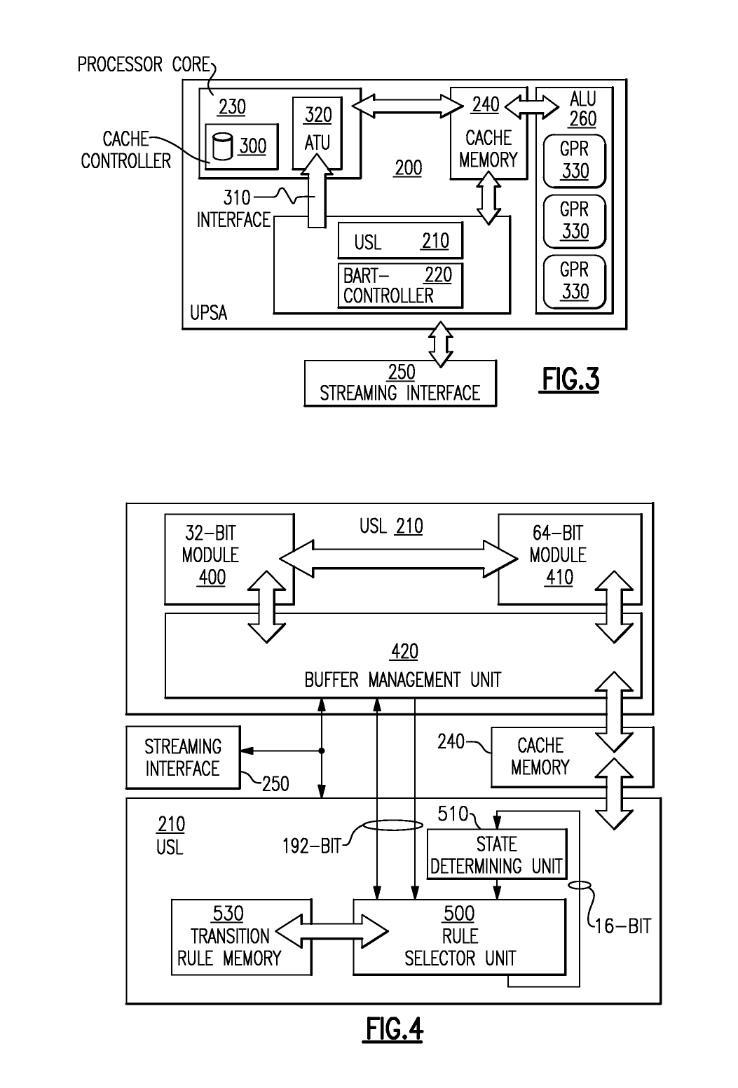

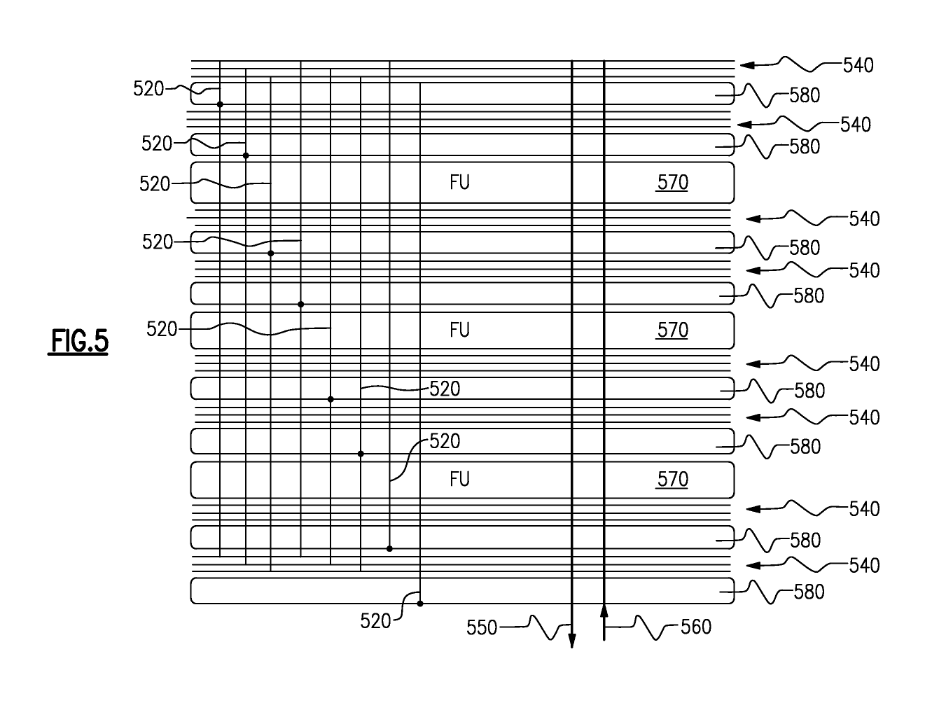

In FIG. 4, there is shown a schematic diagram of an implementation of the USL 210 of the UPSA 200. The USL 210 includes a 32-bit module 400 for performing additions, subtractions and comparisons of data provided thereto. There are included registers and specialized hardware in the 32-bit module 400. There is also included a 64-bit module 410 operable to perform similar arithmetic functions to the 32-bit module 400. The modules 400, 410 are able to mutually exchange data. Moreover, the modules 400, 410 are coupled to a buffer management unit 420. The USL 210 further comprises a rule selector unit 500 operable to receive 16-bit data from the buffer management unit 420 and to send 192-bit data to the unit 420. The rule selector unit 500 is coupled in a cyclical manner with a state determining unit 510. Furthermore, the rule selector unit 500 is bi-directionally coupled to a transition rule memory 530. In operation, the buffer management unit 420 is coupled to the streaming interface 250 and also to the cache memory 240. The USL 210 is configured and managed by the BaRT-controller 220 which provides a wide bit vector, namely a very long instruction word (VLIW), to control all of the USL 210, for example its cache/streaming interface, its GPR's and its arithmetic units in parallel.

Referring next to the BaRT-controller 220, the BaRT-controller 220 is based upon a programmable finite state machine (P-FSM). The BaRT-controller 220 provides for multiple branches and thereby enables increased speed to be achieved in comparison to processors which can branch only once per cycle. Multiple branches accommodated by the BaRT-controller 220 are limited by a size of the P-FSM's transition rule memory. Moreover, the BaRT-controller 220 employs a hash-algorithm which encodes and distributes the transition rules in a selective and targeted manner, thereby saving address space. The BaRT-controller 220 only allocates as much memory as there are transition rules in contradistinction to standard P-FSM which allocate memory for all possible input and output vector combinations. As a result of lower memory consumption, the BaRT-controller 220 in the context of the present invention enables a combination of a universal logic and programmable finite state machine in a practical manner feasible manner.

The BaRT-controller 220 as described in an aforementioned published US patent application no. US 2005/0132342 which is hereby incorporated by reference. The BaRT-controller 220 employs ternary input vectors, namely “0”, “1” and “don't care”, such that state transitions without branches can be made easily by merely applying a “don't care” input. The BaRT-controller 220 is coupled to the GHz clock of the processor core 230 for ensuring greatest operating speed. Fast direct access is provided to both the cache memory 240 and the streaming interface for reducing latencies as they occur to peripheral interconnects.

By reprogramming the BaRT-controller 220, the UPSA 200 can be adapted to various different data streaming applications; such reprogramming is beneficially achieved without a need to reboot.

As aforementioned, the UPSA 200 provides for processing of various data streams whilst providing high bandwidth and low latency. For example, the UPSA 200 is capable of being used to provide a universal method of efficiently processing data streams. The UPSA 200 provides efficient parallel processing support for data streams by using the aforesaid BaRT concept to control arithmetic and logic units of the USL 210. Very long instruction words (VLIW) are employed to directly control different functions of the USL 210 in parallel. The evaluation of conditions to branch into different process steps are also executed in parallel in the UPSA 200.

The UPSA 200 employs a configuration which enables close proximity to hierarchy of the cache memory 240 so that latencies for processing of streamed data are reduced in comparison to contemporary state-of-the-art data processing systems. Moreover, in the UPSA 200, the BaRT-controller 220 employs ternary input vectors, namely “0”, “1” and “don't care” states, which allows for more efficient program code to be employed when the UPSA 200 is in operation. Optionally, an array of BaRT-controllers 220 can be employed to function in parallel, namely synchronize and mutually communicate via a set of registers or data memory. Each of the BaRT-controllers 220 can be used to control a different selection of functional units or functions within the UPSA 200.

The UPSA 200 is thus beneficially implemented to include a processor for processing data, the processor including at least one functional unit (FU) for executing instructions on data, wherein the at least one functional unit (FU) has at least one register associated therewith, the register being operable to hold one or more addresses of one or more registers associated with the at least one functional unit (FU), the one or more registers being addressed by the instructions for providing a direct any-to-any connection between the one or more registers associated with the at least one functional unit (FU), thereby providing a single cycle data path between the at least one functional unit (FU) and its associated one or more registers. Such a configuration provides the UPSA 200 with increasing speed for streaming and/or processing data.

Conventional microprocessors employ functional units (FUs) which are separated from register files containing register contents. For conventionally achieving a short cycle time, instruction processing is split into several cycles. For a register to register instructions, for example adding register R2 content to register R3 content and record a corresponding addition result in register R1, one cycle is used to read register contents R2, R3 from the register file, a second cycle performs the actual addition operation and a third cycle is used to store the result in register R3 in the register file. In transport triggered processor architectures (TTA), registers are attached to a functional unit (FU) and are not separate in a conventional manner. In an extreme, an instruction set for a TTA involves only one instruction: “move”. Multiple FU's are beneficially connected via crossbar switches in a TTA.

For achieving an optimized processor design, for example for use in the aforementioned UPSA 200, single cycle functional units (FU) are beneficially employed.

In FIG. 5, there is shown a configuration of functional units (FU) 570, registers 580, multiplexers 540 and register output buses 520. Furthermore, an output bus 550 and an input bus 560 is indicated. The configuration particularly represents an example embodiment of a processor subunit according to the first aspect of the invention. The configuration is beneficially used in association with a processor for processing data, wherein the processor subunit includes:
(i) a plurality of registers 580;
(ii) at least one functional unit (FU) 570 for executing instructions on data;
(iii) one or more registers 580 of the plurality of registers 580 which are connected to an input of the at least one functional unit (FU) 570;
(iv) each register 580 connected to the input of the at least one functional unit (FU) 570 which has an own input multiplexer 540;
(v) one or more registers 580 of the plurality of registers 580 which are connected to an output of the at least one functional unit (FU) 570;
(vi) each register 580 connected to the output of the at least one functional unit (FU) 570 which has an own input multiplexor 540;
(vii) at least one output bus 550 which is connected to at least one register 580; and
(viii) at least one input bus 560 which is connected to at least one register 580.

In FIG. 5, there are eight registers 580 shown which are closely associated with three functional units (FU) 570. In general, the present invention is capable of being implemented with at least one functional unit (FU) 570 closely associated with a plurality of registers 580. It is beneficial to have buses from all registers to registers closely associated with respective functional units (FU). Optionally, buses can be provided from all functional units (FU) 570 to any register 580. Such arrangements enable permuting contents of a register within one cycle. Moreover, compared to contemporary pipeline processors, the present invention is distinguished therefrom in that operand registers are served directly at the functional units (FU). The invention provides benefits of reducing a requirement for operand registers and associated bypass logic in comparison to contemporary processors; in other words, the present invention circumvents bypassing overheads, independent of the number of functional units (FU) employed.

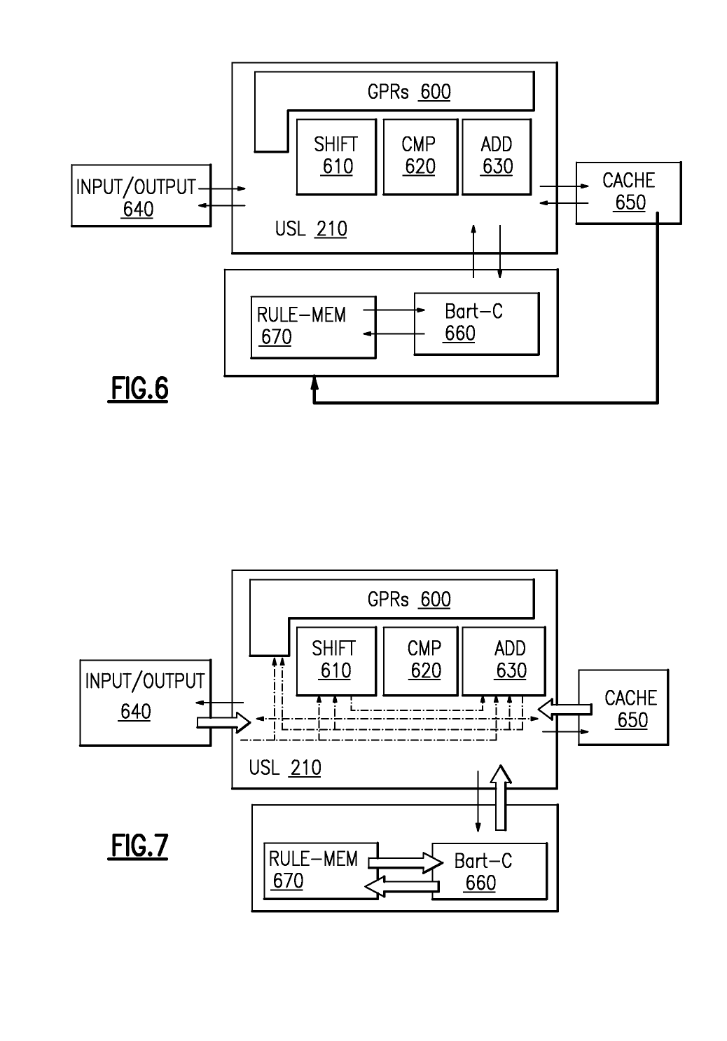

Referring again to the UPSA 200, an example operation is presented in FIG. 6 to FIG. 9. In FIG. 6 to FIG. 9, the UPSA 200 is illustrated with its USL 210 to include general purpose registers (GPRs) 600 associated with shift functions (SHFT) 610, comparison functions (CMP) 620 and addition functions (ADD) 630, an input/output buffer (I/O) 640 and a cache memory (Cache) 650. Moreover, the UPSA 200 also includes a BaRT-controller (BaRT-C) 660 coupled to an associated rule memory (Rule-Mem) 670.

In a first step illustrated in FIG. 6, a BaRT program is loaded from the cache memory 650 to the rule memory 670.

In a second step illustrated in FIG. 7, data is extracted from the input/output buffer (I/O) 640 corresponding to inbound packet requests. Subsequently, corresponding control data is then fetched from memory and is used to configure processing modules of the UPSA 200. The addition function (ADD) 630 provides access addresses for the buffer (I/O) 640. During the second step, the BaRT-controller 660 functions as a step-by-step instructor where input bits are of minor concern. The second step concludes by the USL 210 being fully configured for performing a defined function, for example parsing or decoding.

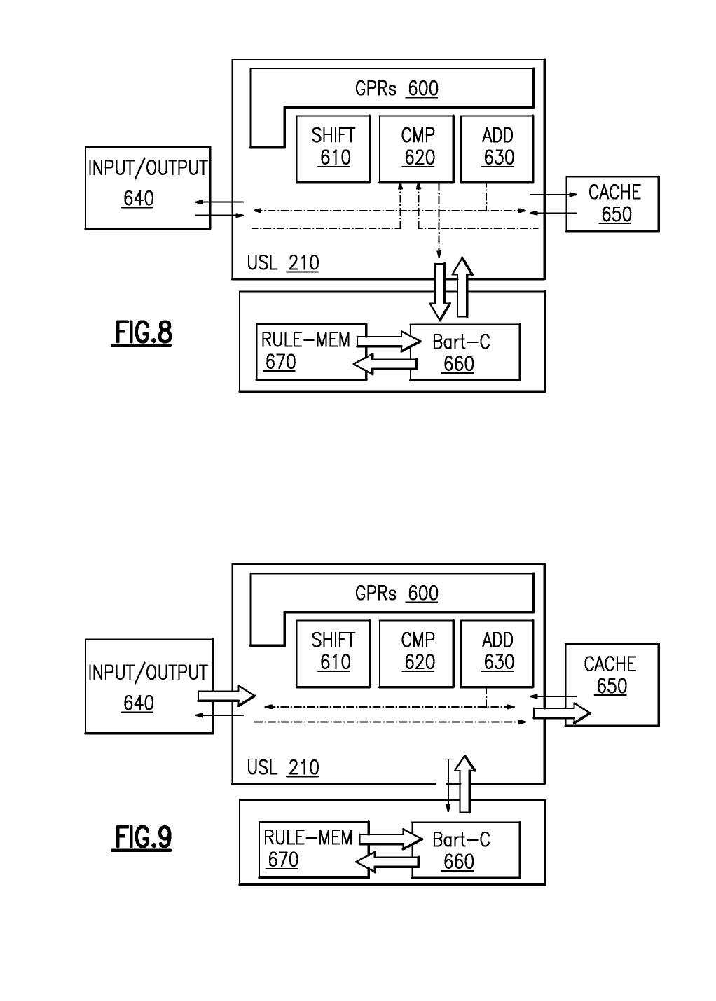

In a third step illustrated in FIG. 8, an inbound data packet is validated against control data for defining a destination target. Thereafter, depending on opcode instructions included within the data packet, different processing paths are chosen within the UPSA 200. Next, access rights to local memory within the UPSA 200 are granted or rejected according to registered memory regions. During this third step, parallel execution capabilities of the BaRT-controller 660 are utilized. In response to data included in the inbound data packet, one or more multiple transition rules are chosen.

In a fourth step illustrated in FIG. 9, a fast bypass route provided in the USL 210 enables data to be transferred at minimum cycle costs from the input/out buffer 640 to memory of the USPA 200 and vice versa. The BaRT-controller 660 synchronized access requests within the UPSA 200 in respect of data buffers and checks for page-crossing and page boundaries.

In conclusion, there is described in the foregoing a processor for processing data, the processor including at least one functional unit (FU) for executing instructions on data, wherein in that the at least one functional unit (FU) has at least one register associated therewith, the register being operable to hold one or more addresses of one or more registers associated with the at least one functional unit (FU), the one or more registers being addressed by the instructions for providing a direct any-to-any connection between the one or more registers associated with the at least one functional unit (FU), thereby providing a single cycle data path between the at least one functional unit (FU) and its associated one or more registers. Such a processor is susceptible to being utilized in various data processing systems and apparatus, for example in the aforementioned UPSA 200. The UPSA 200 beneficially includes at least one BaRT-controller for configuring the UPSA 200, for example with regarded to data pathways therein and also functions to be performed by functional units (FU) of its processor core 230. Moreover, the UPSA 200 is susceptible to being used in consumer electronic devices such as multimedia apparatus, video systems, Internet-coupled devices, wireless communication devices, personal computers and mobile telephones (cell phones) as well as infrastructure devices such as servers, wireless telephone infrastructure, satellites, network servers, transport systems to mention a few diverse examples.

Modifications to embodiments of the invention described in the foregoing are possible without departing from the scope of the invention as defined by the accompanying claims.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer readable medium providing program code for use by or in connection with a computer or any instruction execution system. For the purposes of this description, a computer-usable or computer readable medium can be any apparatus that can contain, store, communicate, propagate, or transport the program for use by on in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read-only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O-devices (including, but not limited to keyboards, displays, pointing devices, etc.) can be coupled to the system either directly or through intervening I/O controllers.

Network adapters may also be coupled to the system to enable the data processing system or remote printers or storage devices through intervening private or public networks. Modems, cable modem and Ethernet cards are just a few of the currently available types of network adapters.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

1. A processor subunit for a processor for processing data, wherein said processor subunit comprises:
a plurality of registers;
at least one functional unit for executing instructions on data;
one or more registers of the plurality of registers which are connected to an input of the at least one functional unit;
each register connected to the input of the at least one functional unit which has an input multiplexer;
one or more registers of the plurality of registers which are connected to an output of the at least one functional unit;
each register connected to the output of the at least one functional unit which has an input multiplexor;
at least one output bus which is connected to at least one register; and
at least one input bus which is connected to at least one register.

2. The processor subunit according to claim 1, wherein the input multiplexers connected by wires form a cross bar switch.

3. The processor subunit according to claim 1, wherein the output of each functional unit is connected to n other registers, preferably to all other registers.

4. The processor subunit according to claim 1, wherein registers connected to the input of the at least one functional unit are writable with an output of at least one other functional unit.

5. The processor subunit according to claim 1, wherein registers connected to the input of the at least one functional unit are writable from at least one other register.

6. A processor for processing data, said processor including at least one functional unit (FU) for executing instructions on data, comprising a processor subunit, the processor subunit comprising:
a plurality of registers;
at least one functional unit for executing instructions on data;
one or more registers of the plurality of registers which are connected to an input of the at least one functional unit;
each register connected to the input of the at least one functional unit which has an input multiplexer;
one or more registers of the plurality of registers which are connected to an output of the at least one functional unit;
each register connected to the output of the at least one functional unit which has an input multiplexor;
at least one output bus which is connected to at least one register; and
at least one input bus which is connected to at least one register.

7. The processor according to claim 6, characterized in that the at least one functional unit (FU) has at least one register associated therewith, said register being operable to hold one or more addresses of one or more registers associated with the at least one functional unit (FU), said one or more registers being addressed by the instructions for providing a direct any-to-any connection between the one or more registers associated with the at least one functional unit (FU), thereby providing a single cycle data path between the at least one functional unit (FU) and its associated one or more registers.

8. The processor according to claim 6, comprising:
a plurality of functional units (FU), each functional unit (FU) being provided with one or more associated registers; and
one or more buses from at least a sub-set of the functional units (FU) to any of the registers.

9. The processor according to anyone of the claims 8, wherein one or more registers operable to store operands served their associated functional units (FU) directly for reducing bypass overheads.

10. The processor according to claim 6, said processor being fabricated into an integrated circuit concurrently with a cache memory, streaming logic and a controller coupled to said processor, wherein said integrated circuit is operable to function as a programmable streaming accelerator.

11. The processor according to claim 10, wherein said controller is coupled to a same nest-frequency clock as the processor.

12. The processor according to claim 10, wherein said controller is a BaRT-controller which is operable to reconfigure said streaming accelerator in response to receiving reconfiguring instructions.

13. The processor according to claim 12, wherein said controller is operable to employ three states of “0”, “1” and “don't care” for enabling stating transitions within the streaming accelerator to be achieved without branches.

14. A programmable streaming accelerator comprising a processor fabricated into an integrated circuit concurrently with a cache memory, streaming logic and a controller coupled to said processor, wherein said integrated circuit is operable to function as said programmable streaming accelerator, wherein the processor comprises at least one functional unit (FU) for executing instructions on data, and a processor subunit, the processor subunit comprising:
a plurality of registers;
at least one functional unit for executing instructions on data;
one or more registers of the plurality of registers which are connected to an input of the at least one functional unit;
each register connected to the input of the at least one functional unit which has an own input multiplexer;
one or more registers of the plurality of registers which are connected to an output of the at least one functional unit;
each register connected to the output of the at least one functional unit which has an own input multiplexor;
at least one output bus which is connected to at least one register; and
at least one input bus which is connected to at least one register.

15. A method of operating a programmable streaming accelerator comprising a processor fabricated into an integrated circuit concurrently with a cache memory, streaming logic and a controller coupled to said processor, wherein said integrated circuit is operable to function as said programmable streaming accelerator, wherein the processor comprises at least one functional unit (FU) for executing instructions on data, and a processor subunit, the processor subunit comprising:
at least one functional unit (FU) for executing instructions on data, comprising a processor subunit, the processor subunit comprising:
a plurality of registers;
at least one functional unit for executing instructions on data;
one or more registers of the plurality of registers which are connected to an input of the at least one functional unit;
each register connected to the input of the at least one functional unit which has an own input multiplexer;
one or more registers of the plurality of registers which are connected to an output of the at least one functional unit;
each register connected to the output of the at least one functional unit which has an own input multiplexor;
at least one output bus which is connected to at least one register; and
at least one input bus which is connected to at least one register;
the method comprising:
(a) loading a configuration program from the cache memory to a rule memory for controlling configuring of the accelerator;
(b) receiving one or more inbound data packet requests, and configuring processing modules within the streaming accelerator pursuant to the requests;
(c) validating at least one inbound data packet against control data for defining a destination target; and
(d) granting access rights within the accelerator within the interface for processing an input stream of data pursuant to the configuration program.
